(19) United States
(12) Patent Application Publication
(10) Pub. No.: US 2006/0070789 A1
(43) Pub. Date: Apr. 6, 2006

(54) Rotatable vehicle accessory

(76) Inventor: John C. Dirkson, Fremont, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/238,803

(22) Filed: Sep. 29, 2005

Related U.S. Application Data
(60) Provisional application No. 60/615,316, filed on Oct. 1, 2004.

(51) Int. Cl. B60K 13/04; A63H 33/40

(52) U.S. Cl. 180/309; 446/217

(57) ABSTRACT

A decorative rotatable accessory includes one or more rotatable decorative elements mounted about a cylindrical vehicle component, such as an automobile exhaust, a motorcycle fork, a head lamp, handle bar, or the like. In one implementation, an assembly comprises an interface that is mounted to the vehicle component. A rotator, which is operably coupled to one or more decorative elements, is coupled to the interface component in such a way that the one or more decorative elements can rotate in response to a wind or air force. In particular, when an air force, such as wind or exhaust pushes against one or more of the decorative elements, or against one or more impeller blades coupled to the decorative elements, the decorative elements rotate, creating a decorative motion effect.

### CROSS-REFERENCE TO RELATED APPLICATIONS

The present invention claims the benefit of priority to U.S. Provisional Patent Application No. 60/615,316, filed on Oct. 1, 2004, entitled “Rotatable Vehicle Accessory”, the entire content of which is incorporated by reference herein.

### BACKGROUND OF THE INVENTION

1. The Field of the Invention

The present invention relates to systems and apparatus that serve as decorative accessories to a vehicle.

2. Background and Relevant Art

Vehicle owners can spend significant time and money customizing their vehicle for a specific look. For example, a motorcyclist may outfit the motorcycle with a specific type of seat cover, or handle bar. Similarly, a car owner may add customized hub caps, a decorative hood, a spoiler, or the like. In short, there are a wide variety of ways in which vehicle owners will customize their given vehicle in order to project a certain look and feel that reflects the owner's tastes.

Recently, rotatable accessories that spin as the vehicle moves, or remain spinning when the vehicle stops have become increasingly popular. One example of a rotatable vehicle accessory is an apparatus having two or more air driven surfaces—a leading surface, and a trailing surface, both of which have a certain drag coefficient. When the ratio of the drag coefficient of the leading surface to the drag coefficient of the trailing surface is equal to or greater than about 1, the vehicle accessory will spin in either a clockwise or counter clockwise rotation as the vehicle increases speed. Other examples of rotatable vehicle accessories include such items as a revolving decorative wheel cover, or a rotating wheel hub. Accessories such as these typically use one or more bearings in conjunction with a wing-like accessory mounted on a wheel hub. The wing-like accessory on the hub rotates independently with respect to the wheel, such that the wing-like accessory continues to rotate even when the wheel stops rotating.

Unfortunately, conventional rotatable accessories are typically limited in how or where they can be used due to a number of practical considerations. In particular, adding conventional rotatable accessories to a grill, motorcycle fork, or exhaust pipe, can be difficult, if not impossible, since significant disassembly of the given vehicle part may be required, or since the vehicle part may be otherwise unsuitable for additional attachments. For example, rotatable accessories that might be used on a handle bar might be destroyed when used in extreme heat environments such as on an exhaust pipe.

### BRIEF SUMMARY OF THE INVENTION

Implementations of the present invention solve one or more of the foregoing problems with decorative vehicular accessories that can add unique decorative effects to a variety of vehicle components with relative ease. In particular, implementations of the present invention include a range of decorative rotatable accessories that can be added to otherwise difficult to access (or to use) vehicle components, such as exhaust pipes, motorcycle forks, automotive lamps, axles, or the like.

For example, in accordance with an implementation of the present invention, a decorative rotatable accessory for mounting about a vehicular component to provide a decorative effect when the vehicle is moving, or at rest after movement, includes, for example, a rotatable interface means. The rotatable interface means can include at least an interface portion configured to fit about a cylindrical vehicle component, as well as a rotator portion mounted about the interface portion. The interface portion can be a barrel configured to fit about an automotive exhaust in one implementation, or can be a clamp configured to attach directly another cylindrical component, such as a motorcycle fork. The rotator portion, on the other hand, can include an outer barrel housing, an impeller assembly, as in the case of use with an automobile exhaust, or can include a second clamp rotatably positioned about the first clamp when used with a motorcycle fork.

The decorative rotatable accessory can also include rotatable decorative means affixed on at least one end to the rotatable interface means. In general, the rotatable decorative means is positioned about a circumference of the cylindrical vehicle component, and is configured to rotate with the rotator portion in response to an air force (e.g., wind and/or exhaust). The rotatable decorative means can include any number of shapes or formations, such as jagged sheets made to resemble flames, or sequentially ordered components that have the appearance of sequential motion when spinning. The rotatable decorative means can also include various items such as light emitting diodes, or phosphorescing elements used to create added visual effects.

In addition, a method of adding a decorative rotatable accessory to a cylindrical vehicle component involves securing first and second inner clamp portions about a cylindrical vehicle component, where the cylindrical vehicle component defines a longitudinal axis. The method also involves securing first and second outer clamp portions about the first and second inner clamp portions, where the first and second outer clamp portions are attached to one or more decorative elements positioned about the longitudinal axis. Furthermore, the method involves positioning one or more rotation enhancing components between the inner clamp portions and the outer clamp portions, such that the outer clamp portions rotate efficiently with respect to the inner clamp portions.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a composite overview of a rotatable decorative accessory attached to an automobile exhaust, in accordance with an implementation of the present invention;

FIG. 1B illustrates a composite overview of a rotatable decorative accessory attached to motorcycle forks in accordance with one or more implementations of the present invention;

FIG. 1C illustrates a composite overview of the rotatable decorative accessory shown in FIG. 1B, except attached to one or more cylindrical components of a truck grill in accordance with one or more implementations of the present invention;

FIG. 1D illustrates a close up side view of the rotatable decorative accessory attached to the truck roof lamp shown in FIG. 1C;

FIG. 2A illustrates a cross-sectional side view of a non-vented decorative accessory in accordance with an implementation of the present invention, which is attached to an automobile exhaust;

FIG. 2B illustrates a partial facing view of the decorative accessory shown in FIG. 2A, in accordance with an implementation of the present invention;

FIG. 2C illustrates a cross-sectional side view of a vented decorative accessory in accordance with an implementation of the present invention, which is also attached to an automobile exhaust, such as in FIG. 2A;

FIG. 2D illustrates a rear perspective view of the decorative accessory shown in FIG. 2C, in accordance with an implementation of the present invention;

FIG. 2E illustrates a facing view of the decorative accessory shown in FIG. 2C, in accordance with an implementation of the present invention;

FIG. 3A illustrates a perspective view of a decorative accessory in accordance with an implementation of the present invention, such as can be attached to a motorcycle fork as shown in FIG. 1B;

FIG. 3B illustrates a perspective cross-sectional view of one or more clamps that can be used to hold a decorative accessory to a post in accordance with an implementation of the present invention, such as the decorative accessory shown in FIG. 3A against a motorcycle fork; and

FIG. 3C illustrates an exploded perspective view of the blades and clamps shown in FIG. 3B.

### DETAILED DESCRIPTION OF THE PREFERRED EMBODIMENTS

The present invention extends to decorative vehicular accessories that can add unique decorative effects to a variety of vehicle components with relative ease. In particular, implementations of the present invention include a range of decorative rotatable accessories that can be added to otherwise difficult to access (or to use) vehicle components, such as exhaust pipes, motorcycle forks, automotive lamps, axles, or the like.

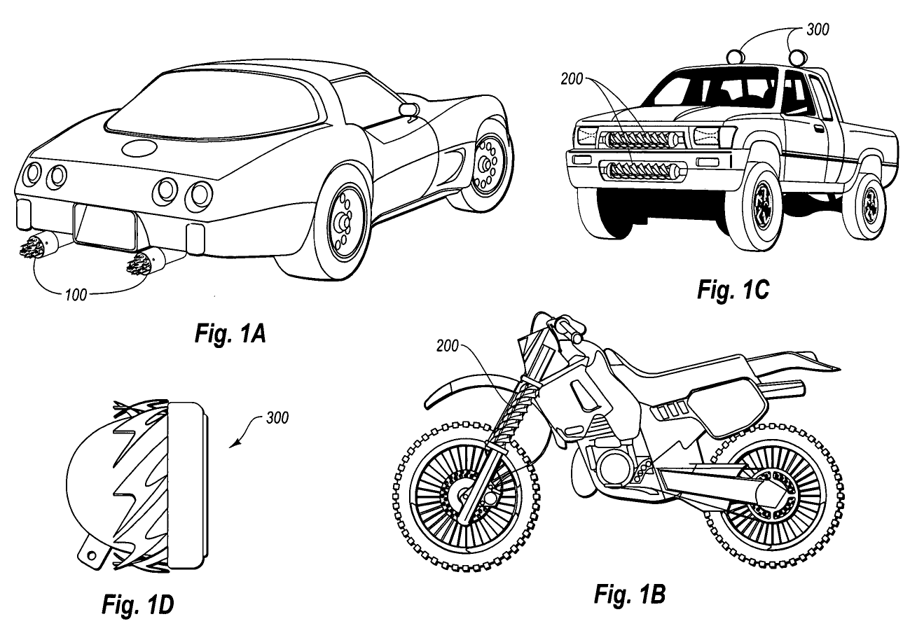

As will be understood more fully from the following specification and claims, a rotatable decorative accessory includes one or more decorative elements attached to a vehicle component via a rotatable interface means. For example, FIG. 1A shows an implementation of a decorative rotatable accessory attached to an automobile exhaust pipe, while FIG. 1B shows an alternative of a decorative rotatable accessory attached to motorcycle forks. As shown, and as will be understood more fully herein, the decorative accessory elements can comprise a blade design, such as rotating flames, or sequentially ordered bullets, which can provide a “Gatling gun” effect. As such that the decorative accessory elements can be configured in a wide variety of ways to provide a desired decorative effect when air or exhaust pushes against the elements.

In general, a rotatable accessory is configured to mount directly to a cylindrical component on the vehicle, such as an exhaust pipe, or motorcycle forks, or even a collar or housing positioned about a head lamp housing 300 (FIGS. 1C-1D). In an implementation for mounting about an exhaust pipe, rotatable interface means comprise one or more barrels that are fitted for the relevant exhaust pipe, and further include an impeller assembly mounted therein. The one or more barrels may be cylindrical shaped as with a conventional exhaust pipe, though they may also take the form of other shapes where appropriate.

The impeller assembly, in turn, can be coupled to the one or more decorative elements, such that when exhaust air exits the exhaust pipe, one or more impeller blades are forced to rotate, further causing the decorative elements to rotate within and/or outside of the impeller assembly. As will be understood more fully hereinafter, the rotatable accessory can also be configured with venting means, such that outside wind/air is directed to a same location where exhaust air passes out of the rotatable accessory, such that the outside wind/air provides a driving and/or a cooling effect.

In another implementation, the rotatable interface means includes an inner first clamp having two semi-circles that are affixed about a portion of a cylindrical vehicle component, such as a motorcycle fork. The rotatable interface means further includes an outer second clamp, which can also be formed in semi-circle portions, and further comprises rotatable decorative means attached thereto. Ball bearings inserted between corresponding grooves of the inner first and outer second clamps can be used to enhance the rotation efficiency of the outer clamp with respect to the inner first clamp. Thus, when a wind force (e.g., the vehicle is in motion) pushes against the rotatable decorative means, one or more decorative elements of the rotatable decorative means efficiently rotate about the cylindrical vehicle component.

Generally, the rotatable decorative means comprise one or more decorative elements that are formed in a roughly cylindrical shape about a longitudinal axis, and/or about a circumference defined by the cylindrical vehicle component. This allows the one or more decorative elements to fit about the corresponding cylindrical vehicle object, or to extend therefrom. In addition, the one or more decorative elements, and any of the other components of the decorative accessory can be fabricated from any type of material such as metal, metal alloy, graphite, ceramic, or suitable plastic, subject to operating conditions of the relevant vehicle component. These various components can also be fabricated with different finishes, using different types of paint, chrome, powder coat, anodizing, or the like to help with fluid rotation, heat or corrosion resistance. The various components can further be configured to include, for example a thin layer of rubber positioned between the rotatable accessory and given vehicle component, to enhance gripping against the vehicle component, while at the same time avoiding scratching of the component surface.

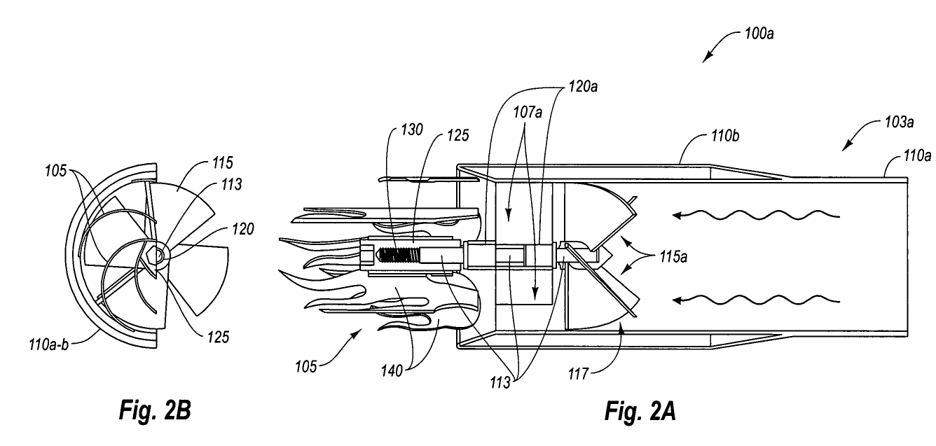

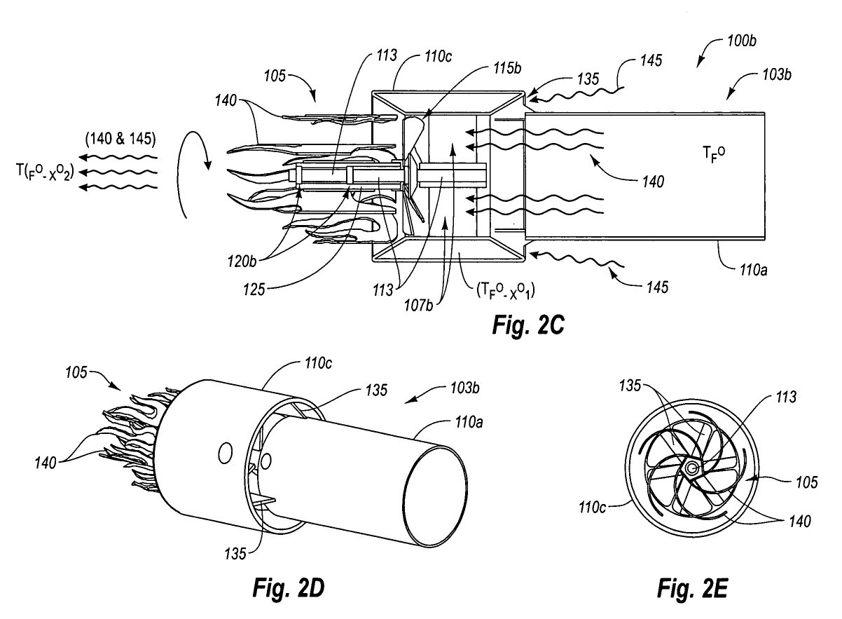

With reference now to the figures, FIG. 2A shows a cross-sectional view of one implementation of a decorative rotatable assembly 100a, which can be mounted about a conventional exhaust pipe of a vehicle (e.g., FIG. 1A). As shown, the decorative rotatable assembly 100a can include a rotatable interface means, such as interface assembly 103a, which has (i) an inner barrel portion 110a that is configured to fit about the conventional exhaust pipe, and (ii) an outer barrel portion 110b extending transverse to a longitudinal axis defined by the inner barrel portion 110a. FIG. 1A also shows that the outer barrel portion 110b has a terminal or distal portion that is larger in circumference than a circumference of the inner barrel. Both the inner barrel 110a and the outer barrel 110b portions define a longitudinal axis that is parallel to a longitudinal axis defined by the relevant cylindrical vehicle component (e.g., exhaust pipe) to which the barrel(s) are attached. In one implementation, the outer barrel portion 110b and the inner barrel portion 110a of the interface assembly 103b are different portions of the same barrel fused together (e.g., FIG. 2A); though barrels 110a and 110b can simply be different barrels secured about each other (e.g., FIG. 2C).

FIG. 2A also shows that the decorative rotatable accessory 100a comprises rotatable decorative means, which can include (i) a decorative element assembly 105; and can also include (ii) an impeller assembly 117. The impeller assembly 117 cooperates with axle 113, and impeller blades 115a, to rotate the decorative elements 140 of the decorative element assembly 105 in response to exiting exhaust air. In particular, decorative element assembly 105 includes at least (i) a flange or nut 125 connected to axle 113 at a distal end, and (ii) one or more decorative elements 140 connected to flange 125. In one implementation, flange or nut 125 and decorative elements 140 can be formed together as a unitary piece that fits about, or screws to threads on, axle 113. In other implementations, however, flange or nut 125 can include one or more slits for receiving corresponding one or more decorative elements 140 therein in a secure fashion.

By contrast, impeller assembly 117 includes (i) one or more blades 115a connected to axle 113 at a proximal end, (ii) an impeller housing 107a, and (iii) axle 113. In some cases, the impeller housing 107a can also include one or more bushings 120a, which in turn receive axle 113 at a central point. For example, impeller housing 107a (also 107b, FIG. 2C) can comprises multiple walls or spokes connected on one end to an inside surface of the outer barrel 110b-c, and connected centrally about bushings 120a or the like, through which axle 113 is inserted.

Generally, FIG. 2A shows that the one or more blades 115a are shaped such that exiting exhaust air forces lateral displacement of blades 115a, thereby driving axle 113 to rotate within bushings 120. Decorative element assembly 105, in turn, rotates as axle 113 rotates, rather than due necessarily to a force provided by exiting exhaust air. For example, as shown in FIG. 2B, the decorative elements 140 are effectively transverse in dimension to the major dimensions of the impeller assembly blades 115a.

One will appreciate that the decorative accessory 100a can increase in temperature levels at the distal end of the exhaust pipe for any number of reasons, including vehicle performance. Accordingly, it may be important in some situations with engines running at higher temperatures for the manufacturer to ensure that the decorative accessory 100a is manufactured from appropriate heat resistant metals, ceramics, or the like, or is coated with appropriately heat-resistant paints and/or related finishes. For example, a manufacture can use a high temperature aluminum insulation paint that is rated at about 1000° F. Paint such as this used on the internal surfaces of decorative accessory 100a (or 100b, FIG. 2C) can insulate the surfaces sufficiently such that little or no heat sinking gets into the corresponding bushing 120. With some more extreme heat conditions, the decorative accessory 100a can also be further modified with enhanced cooling features.

For example, FIG. 2C illustrates decorative accessory 100b, which is an alternative implementation of decorative accessory 100a shown in FIG. 2A. As shown, decorative accessory 100b includes impeller housing 107b, which can be slightly different in arrangement from impeller housing 107a shown in FIG. 2A, but nevertheless receives axle 113 at a central point in rotatable fashion. In further contrast with FIG. 2A, however, impeller blades 115b are located more distal with respect to the inner barrel 110a than shown in FIG. 2A, and are located more proximal to the point at which axle 113 connects to flange 125. This more distal location for impeller blades 115b can be accommodated in at least one instance by positioning bushings 120b at a more distal location along axle 113. In such an implementation, the more distal positioning of the impeller blades 115b can allow the impeller blades 115b to capture not only exiting exhaust air 140, but also to capture wind 145 entering by venting struts 135. As will be discussed more fully below, the entering wind 145 can provide a driving force on the impeller blades 115b, much like the exiting exhaust air 145 (or in lieu thereof). The entering wind 145 can also provide a general cooling effect on the impeller blades 115b and on the decorative accessory 100b, generally.

FIG. 2C further shows that decorative accessory 100b includes an interface assembly 103b having (i) inner barrel 110a, and (ii) outer barrel 110c, which are separated somewhat by venting struts 135. FIGS. 2E and 2D further illustrate facing and perspective views, respectively, of decorative accessory 100b, showing the position of venting struts 135 with respect to decorative elements 105. As shown, venting struts 135 allow outside air 145 to enter between inner barrel 110a and outer barrel 110c. In particular, venting struts 135 are generally formed and positioned to create maximum air flow from a combination of exhaust and outside wind or air, while at the same time providing mechanical stability between inner barrel 110a and outer barrel 110c of interface assembly 103b.

Using venting struts 135 can provide any number of venting, temperature reduction functions in addition to (or in alternative to) any blade 115b rotation caused by the entering wind. For example, in addition to receiving outside air that may be cooler than that inside barrel 110a, any hot air that may be potentially impeded by impeller blades 115b can also have a point of egress through venting struts 135, rather than being stored within interface assembly 103b. As shown, therefore, FIG. 2C shows that exhaust air inside inner barrel 110a has a first temperature (i.e., T_{F°}), which is greater than a second air temperature (i.e., T_{F°}−T_{X°1}) at the point the exhaust air hits impeller blades 115b, and which is still greater than a third air temperature (i.e., T_{F°}−T_{X°2}) at some point after the exhaust air leaves decorative elements 105. In some cases, this venting can reduce the exhaust air temperature inside the interface assembly 103b by as much as from about 100° F. to about 150° F.

For example, one example type of conventional vehicle traveling at one speed might have an exhaust air temperature of about 400° F., which can escalate to about 900° F inside the decorative accessory 100a, and about 750° F. just outside of the decorative elements 105. In some cases, venting the decorative accessory with venting struts 135 can cause the temperature inside decorative accessory 100b to drop to from between about 750° F. to about 800° F., and drop the air just outside the decorative elements to from about 600° F. to about 700° F. While this is an example of an elevated temperature for some operating environments, these types of possible temperature reductions afforded by venting struts 135 can allow for the use of decorative rotatable accessory 100a-b without necessarily risking damage to the decorative accessory or corresponding components.

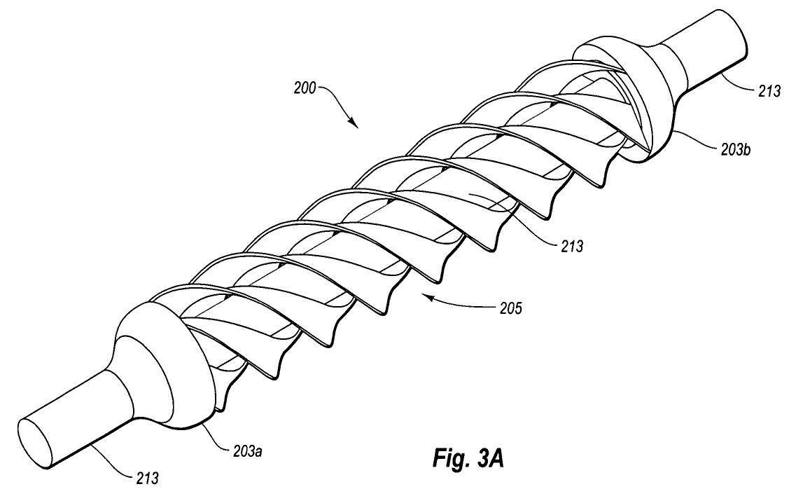

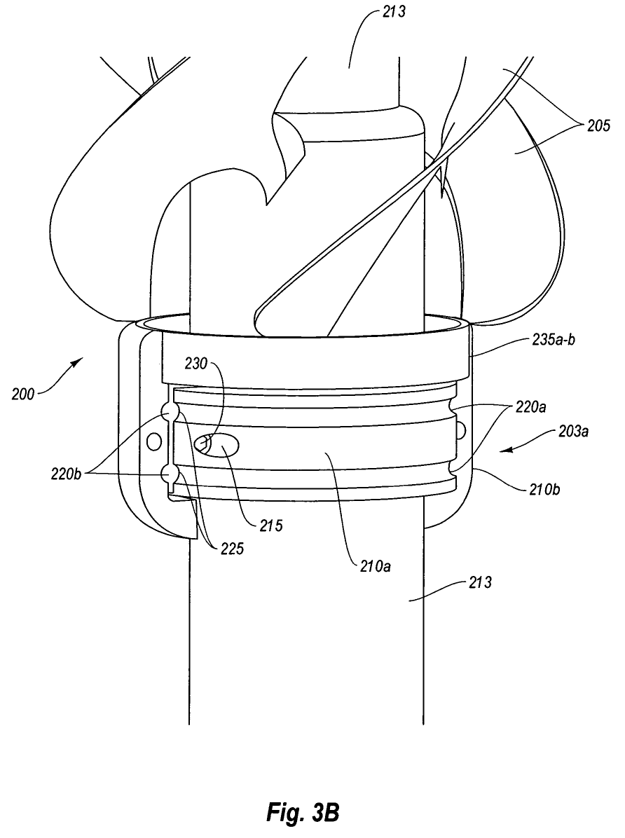

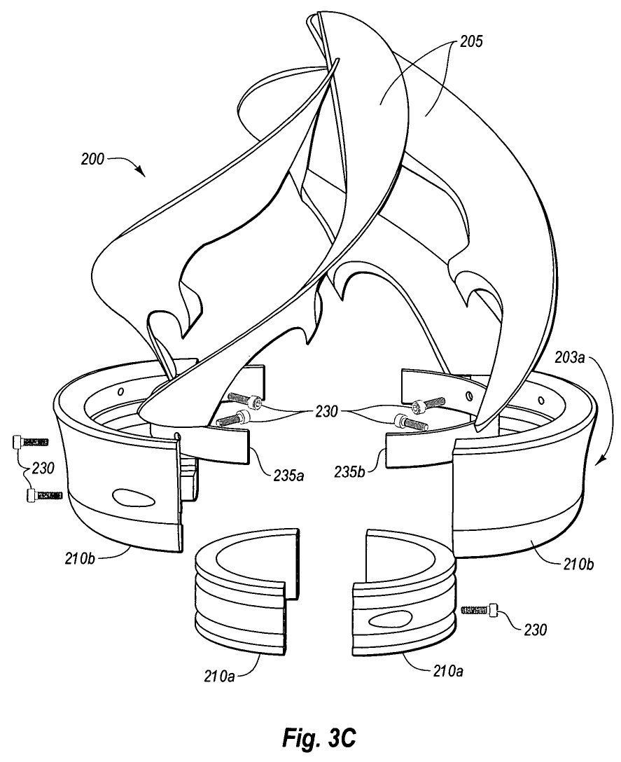

Accordingly, FIGS. 2A-2E illustrate a number of different configurations for positioning one type of rotatable decorative accessory about a cylindrical vehicle component, such as an automobile exhaust. FIGS. 3A through 3C illustrate another alternative implementation of a decorative rotatable accessory in accordance with the present invention. In particular, FIGS. 3A through 3C illustrate another decorative rotatable accessory 200 that can be attached about another cylindrical vehicle component, such as a motorcycle fork. Generally, however, it will be appreciated that vehicle component 213 can include any cylindrical member defining a longitudinal axis, such as the motorcycle fork previously described, as well as handle bars, an exhaust pipe, one or more grill bars on a vehicle grill (e.g., FIG. 1C), runners beside the vehicle, and so forth.

As shown in FIG. 3A, for example, decorative accessory 200 includes an opposing set of one or more clamps 203a-b, which are at least partially fastened to one or more decorative elements 205 on at least one end, and which facilitate rotation of the one or more decorative elements 205 about a cylindrical vehicle component 213. Decorative elements 205 can include uniform winding blades, as well as virtually any other type of design, so long as the decorative elements 205 are formed or positioned in columnar fashion. Other designs or configurations for decorative elements 205 can include, for example, jagged blades, non-uniform blades with a flame-like appearance, blades that extend from one clamp to another in a straight line rather than winding, and so on. As will be understood more fully from the following description and claims, the various elements of decorative accessory 200 need only be configured to rotate with a wind force to thereby produce the desired aesthetic effect on the vehicle component.

To produce the rotating motion, FIG. 3B shows in a cross-sectional perspective view of a decorative accessory (e.g., 200), that the accessory can include a rotatable interface means 203a having (i) an inner first clamp 210a, and (ii) an inner second clamp 210b. The inner first clamp 210a and inner second clamp 210b can each be formed or positioned about cylindrical vehicle component 213 using joined half portions (e.g., semi-circular), as well as by positioning full-size collars over vehicle component 213. That is, in some implementations, inner first clamp 210a can include first and second inner first clamp portions, and, similarly, inner second clamp 210b can include first and second inner second clamp portions. When combining half clamp portions together, inner first clamp 210a and/or inner second clamp 210b can include corresponding perforations 215 for receiving a fastener 230, such as a screw used to join the first and second half portions. Inner first clamp 210a can further be positioned about a thin buffer film, such as a rubber strip positioned about the vehicle component, to thereby minimize any surface-surface scratching.

In any event, FIG. 3B shows that inner first clamp 210a also comprises one or more grooves 220a that correspond with grooves 220b in inner second clamp 210b. After positioning at least a portion of inner first clamp 210a and at least a portion of the inner second clamp together 210b, an assembler can then insert rotation enhancing components, such as loose bearings (not shown), TEFLON or copper bushings (not shown) between overlapping, corresponding grooves 220a-b. The assembler can also insert any lubricants (synthetic or naturally occurring) as appropriate into the same space. As such, inner first clamp 210a will be substantially secured to cylindrical vehicle component 213, and inner second clamp 210b will be configured to rotate efficiently about inner first clamp 210a in response to an appropriate force. As previously mentioned, that force will be provided primarily by a wind force upon decorative elements 205.

Accordingly, FIG. 3B also shows that rotatable interface means 203a comprises a flange 235a-b (see also FIG. 3C), which attaches directly to decorative elements 205, and therefore responds in concert to any forces provided against decorative elements 205. Flange 235a-b can include multiple half parts, such as in the illustrated case of inner first clamp 210a and/or inner second clamp 210b. In such a case, one or more decorative elements 205 can be formed or attached to a first flange portion 235a (e.g., FIG. 3C), while other decorative elements 205 are formed or attached to a second flange portion 235b (e.g., FIG. 3C). In turn, flange 235a-b is connected directly to the moving portion of clamp 203a, such as on an inside surface of second clamp 210b in this example, and is at least partially separated from the non-moving portion of clamp 203a, such as inner first clamp 210a.

FIG. 3C illustrates an exploded perspective view of an implementation of decorative rotatable accessory 200, such as illustrated in embodiments of FIGS. 3A and 3B. FIG. 3C, however, further shows an implementation in which only one rotatable interface means 203a is used at one end of decorative elements 205. In addition, FIG. 3C shows that decorative elements 205 can comprise a more jagged ornamental design that is formed about a columnar formation along a longitudinal axis that is transverse to the circumference of inner first clamp 210a and/or inner second clamp 210b.

Accordingly, one will appreciate that a decorative rotatable accessory in accordance with implementations of the present invention can be created with a variety of features and formations in a manner to be rotated with a wind force. In particular, a wide variety of blade designs and assemblies can be used in accordance with the present invention, as well as colors or other aesthetic effects. For example, the manufacturer or assembler can choose to paint decorative elements 105, 205 with one or more colors 205 for one type of decorative effect.

The manufacturer or assembler can also choose to add other components, such as light emitting diodes (“LED”) for another type of visual effect. For example, the manufacturer can include a generator (not shown) that translates centrifugal forces into electrical energy. The generator can then transmit the electrical energy to one or more LEDs (not shown) positioned on the outside or inside surfaces of decorative elements 105, 205, or even on an inside or outside surface of clamp assemblies 103, 205. Alternatively, the manufacturer may include phosphorescing elements, such as light elements that store sunlight energy during the day time, and release light through phosphorescence in the evening. As such, there are a wide variety of means and components within the context of the present invention for creating a certain type of desired aesthetic effect based on components that rotate in response to a wind and/or exhaust air force.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A decorative rotatable accessory for use with an automobile exhaust pipe comprising:
an inner barrel configured to interface with an exhaust pipe;
an outer barrel having a terminal portion that is larger in circumference than a circumference of the inner barrel; and
one or more decorative elements coupled to the outer barrel, such that exhaust air traveling through at least a portion of the inner barrel and the outer barrel causes the one or more decorative elements to rotate.

2. The decorative rotatable accessory as recited in claim 1, wherein the vehicle component comprises an exhaust pipe.

3. The decorative rotatable accessory as recited in claim 1, wherein the inner barrel and outer barrel are cylindrical.

4. The decorative rotatable accessory as recited in claim 1, further comprising an impeller assembly operatively coupled to the one or more decorative elements, such that the impeller assembly drives rotation of the one or more decorative elements in response to the exhaust air.

5. The decorative rotatable accessory as recited in claim 4, wherein the impeller assembly comprises an axle coupled to the impeller assembly on one end of the axle, and further coupled to the one or more decorative elements on an opposing end of the axle.

6. The decorative rotatable accessory as recited in claim 4, wherein the axle is coupled to the one or more decorative elements via a nut.

7. The decorative rotatable accessory as recited in claim 4, wherein the axle is rotatably inserted inside one or more bushings coupled to the inner barrel.

8. The decorative rotatable accessory as recited in claim 4, further comprising one or more venting struts positioned at a point between the inner barrel and the outer barrel, such that outside air can enter between the one or more venting struts and cool the impeller assembly in addition to the exhaust air.

9. The decorative rotatable accessory as recited in claim 4, further comprising one or more venting struts positioned at a point between the inner barrel and the outer barrel, such that outside air can enter between the one or more venting struts and drive rotation of the impeller assembly.

10. The decorative rotatable accessory as recited in claim 1, wherein the one or more decorative elements comprise jagged edges for producing a flame-like appearance when spinning.

11. The decorative rotatable accessory as recited in claim 1, wherein the one or more decorative elements comprise staggered components positioned to provide the appearance of a sequential motion when spinning.

12. The decorative rotatable accessory as recited in claim 1, further comprising one or more of a light emitting diode and a phosphorescing element for producing a light effect in the decorative rotatable accessory.

13. The decorative rotatable accessory as recited in claim 12, wherein the one or more decorative elements comprise sequentially ordered bullets, such that the sequentially ordered bullets appear to be firing when spinning (e.g., like a Gatling gun).

14. A decorative rotatable accessory for use with a cylindrical automotive member comprising:
a first clamp configured to be positioned about a cylindrical automotive member;
a second clamp configured to be rotatably positioned about the first clamp; and
one or more decorative elements coupled to the second clamp, such that the one or more decorative elements and the second clamp rotate with respect to the first clamp in response to a wind force.

15. The decorative rotatable accessory as recited in claim 14, further comprising an opposing first claim and an opposing second clamp operably coupled to an opposing end of the one or more decorative elements, such that the one or more decorative elements are rotatably coupled to the cylindrical automotive member at two opposing ends.

16. The decorative rotatable accessory as recited in claim 14, further comprising a collar attached to the one or more decorative elements, the collar being configured to mount directly to the second clamp.

17. The decorative rotatable accessory as recited in claim 14, wherein the cylindrical vehicle member is a motorcycle fork, an automotive grill element, or a head lamp.

18. The decorative rotatable accessory as recited in claim 14, wherein the first clamp and the second clamp further comprise corresponding grooves for receiving one or more ball bearings therebetween.

19. A decorative rotatable accessory configured to be mounted about a cylindrical vehicle component to provide a decorative effect when the vehicle is moving or at rest after movement, comprising:
rotatable interface means having at least an interface portion configured to fit about a cylindrical vehicle component, and a rotator portion mounted about the interface portion; and
rotatable decorative means affixed on at least one end to the rotatable interface means, the rotatable decorative means being positioned about a circumference of the cylindrical vehicle component, the rotatable decorative means being configured to rotate with the rotator portion in response to an air force.

20. The rotatable accessory as recited in claim 19, wherein the interface portion comprises one of an inner barrel configured to interface with an exhaust pipe, and wherein the rotator portion comprises at an outer barrel having a terminal portion that is larger in circumference than a circumference of the inner barrel.

21. The rotatable accessory as recited in claim 19, wherein the interface portion comprises a first clamp configured to be positioned about the cylindrical automotive member, and wherein the rotator portion comprises a second clamp configured to be rotatably positioned about the first clamp.

22. The rotatable accessory as recited in claim 19, further comprising venting means for receiving outside air into the rotator portion.

23. The rotatable accessory as recited in claim 19, wherein the rotatable interface means comprises one of a plurality of ball bearings positioned between the interface portion and the rotator portion, or bushings made of a low friction material.

24. The rotatable accessory as recited in claim 19, further comprising light effect means coupled to the decorative rotatable accessory, such that light is emitted during rotation of the rotatable decorative means.

25. A method of adding a decorative rotatable accessory to a cylindrical vehicle component comprising:
securing first and second inner clamp portions about a cylindrical vehicle component, the cylindrical vehicle component defining a longitudinal axis;
securing first and second outer clamp portions about the first and second inner clamp portions, the first and second outer clamp portions being attached to one or more decorative elements positioned about the longitudinal axis; and
positioning one or more rotation enhancing components between the inner clamp portions and the outer clamp portions, such that the outer clamp portions rotate efficiently with respect to the inner clamp portions in response to a wind force.

26. The method as recited in claim 25, wherein the cylindrical vehicle component comprises one of a fork, an axle, an exhaust pipe, or a head lamp.

27. The method as recited in claim 25, further comprising securing opposing inner and outer clamp portions about the cylindrical vehicle component at another end of the one or more decorative elements, such that the one or more decorative elements are rotatably secured to the cylindrical vehicle component at two opposing ends.

28. The method as recited in claim 25, wherein the rotation enhancing components comprise a plurality of ball bearings positioned between the inner clamp portions and the outer clamp portions, or bushings made of a low friction material including TEFLON or copper.
